(19) United States
(12) Patent Application Publication
(10) Pub. No.: US 2015/0231538 A1
(43) Pub. Date: Aug. 20, 2015

(54) FUEL FILTER FOR FUEL DELIVERY SYSTEM

(71) Applicant: Caterpillar Inc., Peoria, IL (US)

(72) Inventor: Chad F. Ahmad, Peoria, IL (US)

(73) Assignee: Caterpillar Inc., Peoria, IL (US)

(21) Appl. No.: 14/183,563

(22) Filed: Feb. 19, 2014

(51) Int. Cl. B01D 35/00

(52) U.S. Cl. CPC B01D 35/005

(57) ABSTRACT

A fuel filter for fuel delivery system is disclosed in the present disclosure. The fuel filter includes housing, a filter media, an end plate, and a filter plug. The housing includes an open end and a closed end. The filter media is disposed inside the housing defining an unfiltered space and a filtered space. The filter media and the open end of the fuel filter are covered by the end plate. The end plate includes at least one vent hole in which the filter plug is mounted. The filter plug filter and vent out the air and/or gases trapped inside the unfiltered space.

### TECHNICAL FIELD

The present disclosure relates generally to a fuel delivery system. More specifically, the present disclosure relates to a fuel filter for the fuel delivery system.

### BACKGROUND

Fuel delivery systems are typically configured to transfer fuel from a fuel tank to an engine. Fuel delivery systems include a fuel filter for filtration of fuel before transferring to the engine. The fuel filter strains particulates and/or other impurities present in fuel. There may be a situation when the fuel filter is used on the suction side of a fuel pump and fuel may evaporate due to heat developed in the fuel delivery system. In this situation, the fuel filter may trap air or fuel vapors developed due to evaporation of fuel. Air or fuel vapors may accumulate in the fuel filter and may result in a situation termed, “vapor lock”. During the situation of vapor lock, delivery of fuel to the engine is blocked. In order to avoid vapor lock, vent holes may be provided in the fuel filters. The vent holes allow air and/or gases to pass through the fuel filter downstream of the fuel filter in the fuel delivery system.

In certain situations, the vent holes may also allow particulates and/or other impurities in fuel to pass downstream to other components in the fuel delivery system. Particulates and/or other impurities passing through the vent holes may result in poor combustion of fuel in the engine. Particulates and/or other impurities present in fuel may also damage downstream components of the fuel filter in the fuel delivery system.

### SUMMARY OF THE DISCLOSURE

The present disclosure is directed to a fuel filter for a fuel delivery system. The fuel filter includes a housing, a filter media, an end plate, and a filter plug. The housing includes an open end and a closed end. The filter media is positioned inside the housing so as to define an unfiltered space and a filtered space. The filter media and the open end of the housing are covered by the end plate. The end plate includes at least one vent hole. The at least one vent hole supports a filter plug. The filter plug allows air and/or gas trapped inside the fuel filter to pass from the unfiltered space to the filtered space and restricts particulates in the fuel within the unfiltered space.

### BRIEF DESCRIPTION OF THE DRAWINGS

FIG. 1 illustrates a block diagram for a fuel delivery system 100, in accordance with the present disclosure; and

FIG. 2 illustrates a sectional view of a fuel filter 104, in accordance with the present disclosure.

### DETAILED DESCRIPTION

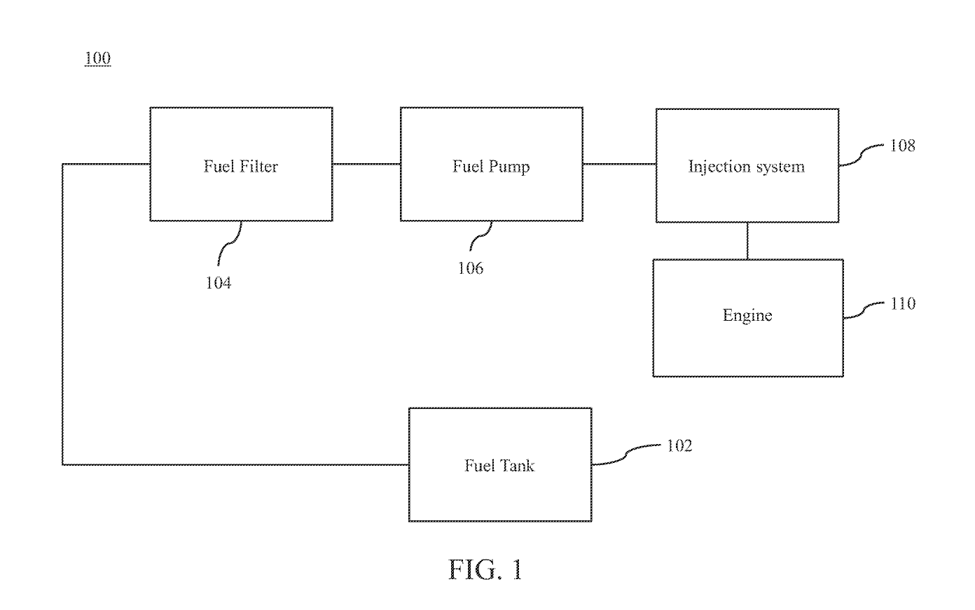

FIG. 1 illustrates a block diagram for a fuel delivery system 100, in accordance with the present disclosure. The fuel delivery system 100 includes a fuel tank 102, a fuel filter 104, a fuel pump 106, an injection system 108, and an engine 110. Within the fuel delivery system 100, fuel from the fuel tank 102 may be transferred to the engine 110, which may generate power for running a machine. Fuel stored in the fuel tank 102 may contain impurities which may harm the other components of the fuel delivery system 100, if not filtered. Therefore, fuel is passed through the fuel filter 104 to remove impurities or particulates present in fuel. After filtration, the fuel may be pumped by the fuel pump 106 and supplied to the injection system 108. The injection system 108 may inject fuel in the engine 110. The engine 110 may generate power required for running a machine by burning the fuel obtained after filtration by the fuel filter 104.

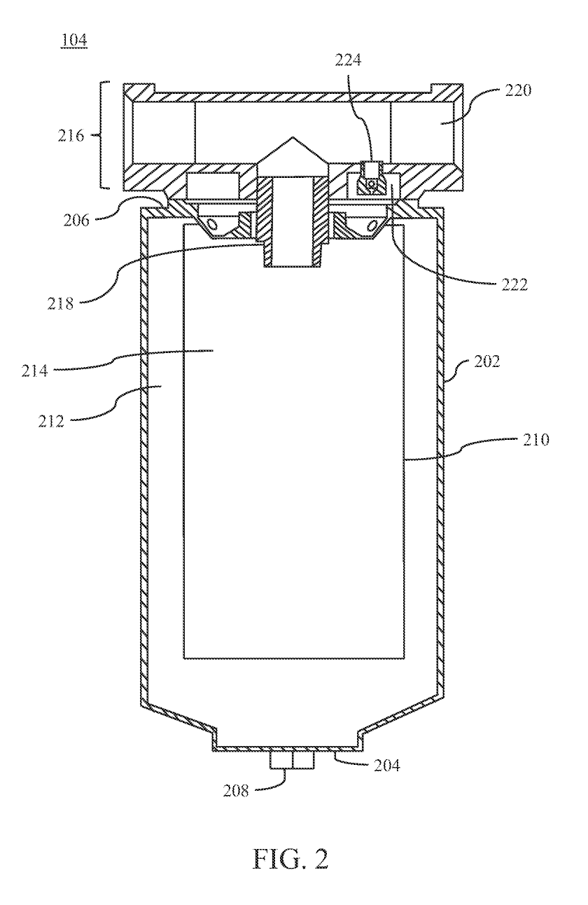

FIG. 2 illustrates a sectional view of the fuel filter 104, in accordance with the present disclosure. The fuel filter 104 is used to remove particulates and/or other impurities present in fuel. Although, the present disclosure is explained with reference to the fuel filter 104 for filtration of fuel, it may be understood to a person ordinarily skilled in the art that the fuel filter 104 may be used to filter any fluid, such as Diesel Exhaust Fluid (DEF), water, coolant, lubricant, and/or the like.

The fuel filter 104 includes a housing 202, a filter media 210, an end plate 216, and a filter plug 224. The housing 202 of the fuel filter 104 may be a hollow body which is generally cylindrical in shape. The housing 202 includes a closed end 204 and an open end 206. The closed end 204 may include a draining nut 208 to drain out fuel, when required. The housing 202 forms an internal cavity in the hollow body where the filter media 210 is supported by the housing 202.

The filter media 210 is positioned inside the cavity on the housing 202 of the fuel filter 104. The filter media 210 may be configured in the form of a hollow cylinder sharing a common longitudinal axis with the housing 202. The filter media 210 is formed from a material of very small bore size which retains particles while allowing the liquid fuel to flow through, thereby filtering the fuel. The filter media 210 defines an unfiltered space 212 between the outer side of the filter media 210 and the housing 202. The filter media 210 also defines a filtered space 214 inside the filter media 210. The filtered space 214 is a space where filtered fuel is present in the fuel filter 104. Hence, the filter media 210 acts as a screen between the unfiltered space 212 and the filtered space 214. To be filtered, fuel containing impurities may pass radially from the unfiltered space 212 to an inner side or the filtered space 214 of the filter media 210. Hence, the filter media 210 provides the filter fuel in the filtered space 214. The filtered space 214 may extend from the inner side of the filter media 210 to a predetermined part of the end plate 216.

The end plate 216 may be configured to cooperate with the open end 206 of the housing 202, thereby completely enclosing the filter media 210. In other words, the end plate 216 is configured to cover the filter media 210 and the open end 206 of the housing 202. The end plate 216 and the housing 202 may cooperate by, but not limited to, a press fitted or snap fitted, pivoted, or any other method known to a person ordinarily skilled in the art. The end plate 216 may define openings for the inlet and /or outlet of fuel. The end plate 216 may include a suction port 218 extending from the inner side of the filter media 210. Further, a delivery channel 220 may also extend horizontally from the suction port 218. The suction port 218 and the delivery channel 220 forms a ‘T’ section in the end plate 216 with the inner side of the filter media 210. Therefore, the inner side of the filter media 210, the suction port 218, and the delivery channel 220, in conjunction, form the filtered space 214 within the end plate 216. The end plate 216 is designed in a manner such that the air and/or gases trapped inside the fuel filter 104 flow to the highest point on the end plate 216. The end plate 216 includes at least one vent hole 222 at the highest point, such that air and/or gases trapped inside the fuel filter 104 are allowed to pass from the unfiltered space 212 to the filtered space 214 of the delivery channel 220. The at least one vent hole 222 includes the filter plug 224 capable of filtering out air, gases and/or fuel passing through the at least one vent hole 222. The filter plug 224 restricts particulates in fuel within the unfiltered space 212 and allows air and/or gases to pass through. The filter plug 224 may be removed, if required, for cleaning purposes.

In operation, fuel enters the fuel filter 104 in the unfiltered space 212. Thereafter, fuel passes radially inward through the filter media 210 wherein particulate material is removed. After filtration, the fuel reaches the filtered space 214 and is then passed through the suction port 218 and exits the filter media 210 through the delivery channel 220. During filtration, air and/or gases may become trapped in the unfiltered space 212. Air and/or gases trapped inside the fuel filter 104 are thus evacuated from the unfiltered space 212 through the at least one vent hole 222, which is present in the end plate 216. The at least one vent hole 222 vents the trapped air and/or gases to the filtered space 214 in the delivery channel 220. In order to avoid particulates in fuel passing to the filtered space 214 through the at least one vent hole 222 and thereby into the delivery channel 220, the filter plug 224 is positioned inside the at least one vent hole 222. The filter plug 224 allows air and/or gases to pass through and restricts particulates in fuel within the unfiltered space 212. A filtered supply of fuel is thus provided in the delivery channel 220.

### INDUSTRIAL APPLICABILITY

The fuel delivery system 100 includes the fuel pump 106, the fuel filter 104, and the injection system 108, which may coordinate to deliver filtered fuel to the engine 110 to generate power. The fuel filter 104 includes the housing 202 with the closed end 204 and the open end 206, the filter media 210, the end plate 216, and the filter plug 224 mounted inside the at least one vent hole 222 on the end plate 216. The fuel filter 104, in certain situations, such as heating of fuel and the fuel filter 104 positioned on the vacuum side of the fuel pump 106, may trap air and/or gases. Air and/or gases may accumulate in the fuel filter 104 and may develop a situation termed, “vapor lock”. In the situation of vapor lock, fuel may not be supplied by the fuel filter 104 to the engine 110. Therefore, air and/or gases trapped inside the fuel filter 104 may act as barrier to the transport of fuel.

To avoid the situation of vapor lock, the at least one vent hole 222 may be provided in the end plate 216 installed on the open end 206 of the housing 202. The at least one vent hole 222 may allow air and/or gases trapped inside the fuel filter 104 to pass downstream within the fuel delivery system 100. The at least one vent hole 222, in certain situations, allows particulates and/or other impurities present in fuel to pass through. This may harm components downstream of the fuel filter 104 in the fuel delivery system 100. In order to avoid particulates and/or other impurities to flow downstream the fuel filter 104, the filter plug 224 is positioned inside the at least one vent hole 222.

The filter plug 224 allows air and/or gases to pass through and restricts particulates and/or other impurities present in fuel within the unfiltered space 212. Restriction of particulates and/or other impurities present in fuel ensures clean fuel supplied to the engine 110 and thus efficiency of the system is improved by avoiding damage to components downstream of the fuel filter 104 in the fuel delivery system 100. Therefore, the present disclosure avoids the problem of vapor lock while it maintains the quality of filtration in the fuel filter 104.

What is claimed is:

1. A fuel filter for a fuel delivery system, the fuel filter comprising:
a housing comprising an open end and a closed end;
a filter media positioned inside the housing defining an unfiltered space and a filtered space;
an end plate having at least one vent hole, the end plate is configured to cover the open end of the housing; and
a filter plug mounted inside the at least one vent hole, the filter plug configured to allow gases to pass from the unfiltered space to the filtered space and to contain particulates present in fuel within the unfiltered space.
